(19) United States
(12) Patent Application Publication
(10) Pub. No.: US 2010/0158391 A1
(43) Pub. Date: Jun. 24, 2010

(54) IDENTIFICATION AND TRANSFER OF A MEDIA OBJECT SEGMENT FROM ONE COMMUNICATIONS NETWORK TO ANOTHER

(75) Inventors: Ryan B. CUNNINGHAM, San Francisco, CA (US); Michael G. FOLGNER, Burlingame, CA (US)

Correspondence Address: YAHOO C/O MOFO PALO ALTO, 755 PAGE MILL ROAD, PALO ALTO, CA, 94304, US

(73) Assignee: YAHOO! INC., Sunnyvale, CA (US)

(21) Appl. No.: 12/344,148

(22) Filed: Dec. 24, 2008

(51) Int. Cl. G06K 9/64

(52) U.S. Cl. 382/209

(57) ABSTRACT

Technology for sharing media objects includes receiving image selection data associated with a first media object, where the first media object is a television broadcast video. A media server maybe included for storing a second media object. In one embodiment, the second media object is a recording of the broadcast of the first media object. In another embodiment, the second media object may be loaded into a media object database within the media server separate from the television broadcast. The media server may then identify a segment of the second media object by comparing the image selection data with data representing at least a portion of the second media object. The media server may then send the segment to a second user. In one embodiment, sending the segment to a second user may include sending a web-link reference to the segment. The media server may also send or cause the transmission of advertising data related to the image selection data.

### BACKGROUND

1. Field

The present technology relates generally to sharing media objects online.

2. Related Art

Currently, people watch far more broadcast video (either live video or pre-recorded broadcast video) on television than on the Internet. However, the television infrastructure does not have the same social context that users experience on the internet. For example, technical difficulties hamper the transfer of files between the television set-top box, such as a digital video recorder (DVR), to other environments, such as a web browser. As a result, users have difficulty sharing interesting clips of broadcast video with friends and family.

Thus, there exists a need to provide television viewers the ability to quickly and easily identify and share broadcast video with friends, family, and others.

### SUMMARY

Embodiments are directed to sharing television broadcast video over the internet. According to one example, sharing media objects, such as video clips, includes receiving image selection data associated with a first media object from a first user. The method further includes identifying a segment of a second media object by comparing the image selection data with data representing at least a portion of the second media object and includes sending the segment to a second user. In one example, the segment of the second media object may include the entire second media object. In another example, sending the segment to a second user includes sending a web-link reference to the segment.

In one example, the second media object may be a copy of the first media object. The image selection data may include at least one image from the first media object, a hash or fingerprint of at least one image from the first media object, or a compressed video packet. In another example, identifying a segment of the second media object further comprises comparing metadata associated with the first media object with metadata associated with the second media object. The metadata associated with the first media object and the metadata associated with the second media object may comprise at least one of program name, program description, current time, time into a program, channel, service provider, information about the first user, information about the second user, information associated with an advertisement, and viewing location.

In another example, the act of comparing the image selection data with data representing at least a portion of the second media object may include the use of an image comparison algorithm. In another example, the method further includes sending advertising data associated with the segment in response to receiving image selection data

According to another aspect, a system is provided for sharing media objects. The system may comprise memory for storing program code, the program code comprising instructions for receiving image selection data associated with a first media object from a first user, wherein the first media object is a television broadcast video, identifying a segment of a second media object by comparing the image selection data with data representing at least a portion of the second media object, and sending the segment to a second user, and a processor for executing instructions stored in the memory.

According to another aspect, an interface is provided for displaying a media object, the interface including a display portion for displaying a segment of a media object, the segment identified by comparing image selection data with data representing at least a portion of the media object. The interface further includes a graphical user element for adjusting a start point and an end point of the segment. The interface may further allow a first user to input data associated with a second user or select a second user.

Many of the techniques described here may be implemented in hardware, firmware, software, or combinations thereof. In one example, the techniques are implemented in computer programs executing on programmable computers that each includes a processor, a storage medium readable by the processor (including volatile and nonvolatile memory and/or storage elements), and suitable input and output devices. Program code is applied to data entered using an input device to perform the functions described and to generate output information. The output information is applied to one or more output devices. Moreover, each program may be implemented in a high level procedural or object-oriented programming language to communicate with a computer system. However, the programs can be implemented in assembly or machine language, if desired. In any case, the language may be a compiled or interpreted language.

### BRIEF DESCRIPTION OF THE DRAWINGS

FIG. 1 illustrates an exemplary environment in which certain aspects and examples of the systems and methods described may be carried out.

FIG. 2 illustrates an exemplary method for identifying a selected segment of a media object and sending the segment to an internet user.

FIG. 3 illustrates an exemplary method for sending advertising data in response to receiving image selection data from a user.

FIG. 4 illustrates an exemplary interface for displaying and adjusting the media object segments.

FIG. 5 illustrates a typical computing system that may be employed to implement some or all processing functionality of certain embodiments of the subject technology.

### DETAILED DESCRIPTION

The following description is presented to enable a person of ordinary skill in the art to make and use the subject technology. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the subject technology. Thus, the present technology is not intended to be limited to the examples described herein and shown, but is to be accorded the scope consistent with the claims.

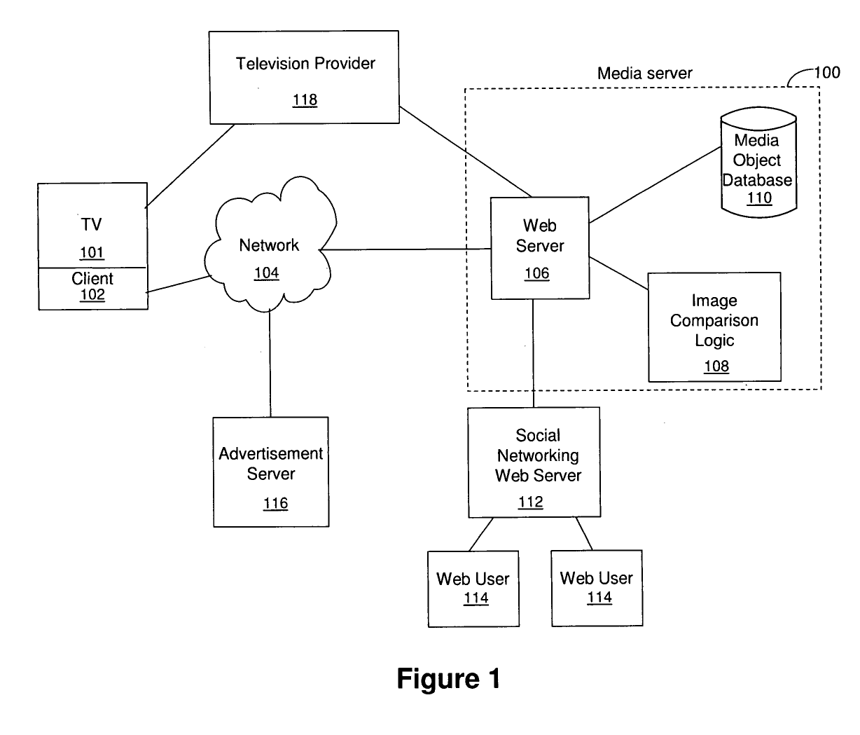

FIG. 1 illustrates a block diagram of an exemplary environment in which certain aspects of the system may operate. Generally, clients 102 coupled to television sets 101 may access media server 100. While only one television 101 and one client 102 are shown, it should be understood that any number of televisions 101 and clients 102 may be used. Media server 100 may include web server 106 for interfacing with network 104. Web server 106 and clients 102 of the present technology may include any one of various types of computer devices, having, e.g., a processing unit, a memory (including a permanent storage device), and a communication interface, as well as other conventional computer components (e.g., input device, such as a keyboard and mouse, output device, such as display). Client device 102 may be a set-top box, personal computer, mobile device, and the like. For example, client device 102 may be a set-top box including a recorder, editor, encoder, and transmitter to capture and transmit images and data packets to web server 106.

Clients 102 and web server 106 may communicate, e.g., via suitable communication interfaces via a network 104, such as the Internet. Clients 102 and web server 106 may communicate, in part or in whole, via wireless or hardwired communications, such as Ethernet, IEEE 802.11b wireless, or the like. Additionally, communication between clients 102 and web server 106 may include various servers such as a mail server, mobile server, and the like.

Media server 100 may further include or access image comparison logic 108 and media object database 110. In one example, media server 100 may use image comparison logic 108 to compare media objects to identify similarities between media objects (e.g., that the media objects are duplicates, are subsets of each other, illustrate the same person/place/thing, etc.) The methods of comparing media objects will be discussed in greater detail below. As used in this application, “media objects” may include such items as an image, multiple images, a video clip, an entire television program, and the like. Media server 100 may further use media object database 110 to store a set of media objects.

In one example, web server 106 may send data (e.g., image selection data associated with a media object) received from clients 102 to image comparison logic 108. The image selection data provides information for comparison between two media objects to determine a common reference point between the media objects (e.g., same point in time in a television program). Examples of image selection data associated with a media object include an image frame, a plurality of image frames, an encoded broadcast packet, a hash or fingerprint of an image, a hash or fingerprint of a plurality of images, and the like. Image comparison logic 108 may further receive media objects or data representing at least a portion of a media object from media object database 110 to compare with the image selection data received from media server 106. As used herein, the data representing at least a portion of a media object may include the entire media object, a subset of the media object, a hash or fingerprint representation of the media object, a compressed version of the media object, and the like. For example, the data representing at least a portion of an image may include a smaller segment of the entire image.

In one example, television 101 and media server 100 may receive a television broadcast from provider 118. Media server 100 may capture video from the television broadcast and store them as media objects (e.g., continuous video) in media object database 110. Thus, media object database 110 may contain copies of the media objects broadcast to televisions 101. In another example, the media objects may be loaded into media object database 110. For example, a television service provider or a production studio may load media objects (e.g., videos, images, and the like) of their programs into media object database 110. The media objects may be full copies of the programs or partial copies of the programs. In this example, media server 100 would not have to perform a video capture of the television broadcast as the media objects would be loaded into media object database 110 independent from the broadcast. It should be appreciated that the media objects may be loaded into media object database 110 before, during, or after the actual broadcast of the media object to television 101.

In one example, media server 100 may receive image selection data associated with a television broadcast video from client 102. The data may be received by web server 106 and sent to image comparison logic 108. Image comparison logic 108 may further receive data stored in media object database 110. One of ordinary skill in the art would appreciate that media object database 110 may be located within media server 100 or be located remotely from the server. If located remotely, media server 100 may access media object database 110 through a network similar to network 104. Image comparison logic 108 may further compare the image selection data associated with the television broadcast with the data stored within media object database 110. The method of comparison will be described in greater detail below.

Web server 106 may, as an example, be programmed to format data, accessed from local or remote databases or other sources of data, for comparison and presentation to users, in the format discussed in detail herein. Web server 106 may utilize various Web data interface techniques such as Common Gateway Interface (CGI) protocol and associated applications (or “scripts”), Java® “servlets”, i.e., Java applications running on the Web server, or the like to present information and receive input from clients 102. The web server 106, although described herein in the singular, may actually comprise plural computers, devices, backends, and the like, communicating (wired and/or wireless) and cooperating to perform the functions described herein.

FIG. 1 further illustrates an advertisement server 116, which may communicate through network 104 with one or more clients 102. In another example, advertisement server 116 may communicate through network 104 with one or more clients 102 and media server 100. It should be appreciated that advertisement server 116 may alternatively be connected directly to media server 100 or even located within media server 100. In one example, advertisement server 116 may contain information regarding various products and services. For example, advertisement server 116 may contain commercials, product/service prices, coupons, promotions, and the like. In another example, advertisers may upload product and service information into advertisement server 116.

In one example, advertisement server 116 may operate to associate advertisements with the image selection data associated with the media objects sent from client 102 to media server 100. More specifically, an advertisement may be associated with the particular media object selected by users via client 102 or the particular segment of the media object selected by users via client 102. For example, an advertisement may be associated with a media object based on the type of show playing or a particular product or service being displayed.

In another example, advertisement server 116 may operate to send advertisements requested by media server 100. For example, media server 100 may request a specific advertisement or advertisements related to a particular product or service. In such an example, advertisement server 116 may operate to send the requested advertising data to media server 100.

In another example, advertisement server 116 may be replaced with a searchable advertisement database. In such a configuration, image comparison logic 108 may search the database for advertising data such as advertisement media objects and associated metadata. Examples of metadata include advertisement name, advertisement description, associated product or service, channel the advertisement appeared on, television service provider, geographical location of the user, time the selection was made, and the amount of time into the advertisement when the selection was made. The advertisement database may be located remotely or within media server 100. In another example, advertisers may upload product and service information into the searchable advertisement database.

It will be recognized that the elements of FIG. 1 are illustrated as separate items for illustrative purposes only. In some examples, various features may be included in whole or in part with a common server device, server system or provider network (e.g., a common backend), or the like; conversely, individually shown devices may comprise multiple devices and be distributed over multiple locations. Further, various additional servers and devices may be included such as web servers, media servers, mail servers, mobile servers, and the like as will be appreciated by those of ordinary skill in the art.

In one example, social networking web server 112 may be included for displaying the selected segment of the media object to web user client 114. Social networking web server 112 allows a user of client 102 to share media objects with others, such as friends or family, over the internet on a social networking website such as Facebook, MySpace, YouTube, Yahoo!, and the like. It should be understood by one of ordinary skill in the art that any website or application that holds user contact information and allows the user to “share” media objects may be used. Social networking web server 112 is illustrated as being connected to web server 106. It should be appreciated however, that social networking web server 112 may alternatively communicate with media server 100 through network 104 or may even be included within media server 100. In another example, web user client 114 may connect directly to web server 106 without the use of social networking web server 112. In such a configuration, web server 106 may send media objects directly to web user client 114 or via network 104.

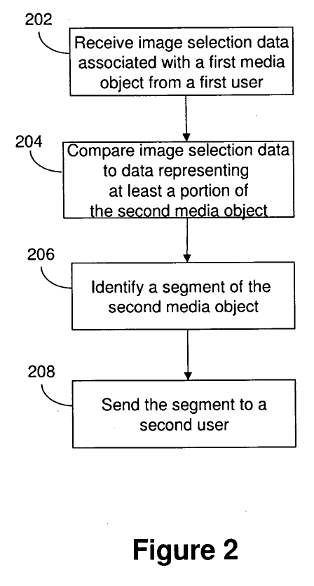

FIG. 2 illustrates a method for identifying a selected segment of a media object and sending the segment to an internet user. At block 202 the method includes receiving image selection data associated with a first media object from a first user.

In one example, the image selection data is generated by client 102 in response to a selection by a user of television 101. Client 102 allows a user of television 101 to selectively identify an interesting segment or image of the media object that is being displayed on the television. In one example, this may be accomplished by pressing a button on the remote control or by pressing a button on the set-top box. In one example, this button may be reserved for the purpose of selecting an interesting segment or image and causing the transmission of image selection data. In another example, the selection of an interesting segment or image may be accomplished by selecting an option from a menu. In response to the user selection, client 102 may store the image selection data (image frame, plurality of image frames, hash, fingerprint, encoded broadcast packet, etc.) for transmission to web server 106. For example, client 102 may take a screen shot, record a few seconds of video, or save an incoming encoded broadcast packet. In another example, client 102 may generate a hash or fingerprint of the screenshot or few seconds of video and transmit the hash or fingerprint to media server 100 as image selection data. It should be appreciated that client 102 may wait for a suitable internet connection, wait for a user command, or immediately send the image selection data to media server 100.

At block 204, the method includes comparing the image selection data to data representing at least a portion of a second media object. In one example, the second media object is a copy of the first media object associated with the image selection data. For example, the second media object may be an exact copy of the first media object or may be a recording of the content contained in the first media object. Comparing the image selection data to data representing at least a portion of the second media object identifies the image or segment of the second media object that corresponds to the image or segment selected by the user of television 101. For example, identifying the second media object that is a copy of the first media object.

Image comparison logic 108 may compare the image selection data received from client 102 with the data representing at least a portion of the media objects stored in media object database 110. Media object database 110 may contain a set of media objects as well as the data representing at least a portion of the media objects stored therein. For example, media object database 110 may contain a media object as well as a compressed version of the media object. The image selection data and data representing at least a portion of the stored media object are compared in order to find the image/segment of the stored media object that corresponds to the image or segment selected by the user, thus identifying the point in time of the video that the user made a selection.

In one example, image comparison logic 108 may identify similarities between media objects using an image comparison algorithm. For example, image comparison logic 108 may compare a hash of each media object. While in some instances, the hash comparison used by image comparison logic 108 may look for an exact match between the image selection data and data representing at least a portion of the second media object, image comparison logic 108 may further correct for color and contrast distortion, other compression artifacts, and broadcast artifacts (e.g. a broadcast capture may have a couple of lines of black pixels at the top of the image). For example, two media objects may contain video captures of the same television program, but minor color differences may be present due to varying television settings. Image comparison logic 108 may account for these differences and still find a match between the two media objects even though the colors of the two media objects are not identical.

Methods for generating and comparing a hash as discussed above are described in more detail by “Image Hashing Resilient to Geometric and Filtering Operations,” by Ashwin Swaminathan, Yinian Mao and Min Wu, presented at the IEEE Workshop on Multimedia Signal Processing (MMSP), pp. 355-358, Siena, Italy, September 2004 (provided at “http://terpconnect.umd.edu/˜ashwins/pdf/MMSP04.pdf”), “A Signal Processing and Randomization Perspective of Robust and Secure Image Hashing,” by Min Wu, Yinian Mao, and Ashwin Swaminathan, presented at the IEEE workshop on statistical signal processing (SSP), pp. 166-170, Madison, Wis., August 2007 (provided at “http://terpconnect.umd.edu/˜ashwins/pdf/SSP07.pdf”), “Dither-Based Secure Image Hashing Using Distributed Source Coding,” by M. Johnson and K. Ramchandran, presented at the Proceedings of the IEEE International Conference on Image Processing (ICIP), Barcelona, Spain, September 2003 (provided at “http://www.cs.berkeley.edu/˜mjohnson/papers/icip03.pdf”), and “An Extendible Hash for Multi-Precision Similarity Querying of Image Databases,” by Shu Lin, M. Tamer Özsu, Vincent Oria, and Raymond T. Ng, presented at the 27th International Conference on Very Large Data Bases, Roma, Italy, Sep. 11-14, 2001 (provided at “http://www.vldb.org/conf/2001/P221.pdf”), which are incorporated herein by reference in their entirety.

In another example, image comparison logic 108 may employ the fast Fourier Transform as applied to solving a degenerate sub-image problem, as is well known by those skilled in the art, such as that described by the publication written by Werner Van Belle, “An Adaptive Filter for the Correct Localization of Subimages: FFT based Subimage Localization Requires Image Normalization to work properly,” published by Yellowcouch Scientific in October 2007 (provided at “http://werner.yellowcouch.org/Papers/subimg/index.html”), which is incorporated herein by reference in its entirety. Other comparison algorithms that are well known by those of ordinary skill in the art may be used. Such algorithms may include a binary match algorithm.

In one example, client 102 may send an image or video to media server 100 as image selection data. Image comparison logic 108 may then compare the image selection data with data representing at least a portion of the media objects stored in media objects database 110 using a matching algorithm, such as the fast Fourier Transform as applied to solving a degenerate sub-image problem. Image comparison logic 108 may determine a match between the image selection data and the data representing at least a portion of the media object upon the matching algorithm returning a matching score reaching a predetermined threshold.

In one example, an exact match between the image selection data and the data representing at least a portion of the media object is desired. As such, a high threshold, as determined by the particular comparison algorithm, may be used. The threshold may further be adjusted based on the quality of the both the image selection data and the data representing at least a portion of the media object. For instance, when the image selection data and the data representing at least a portion of the media object include images of dissimilar resolution, a lower matching score is expected from the comparison algorithm. Thus, the threshold value may be lowered to account for the reduction in score due to the resolution differences.

In another example, client 102 may create a hash or fingerprint of an image or video and send the hash to media server 100 as image selection data. In such an example, image comparison logic 108 may then generate a hash or fingerprint of a media object stored in media object database 110 to compare to the received hash in the image selection data. Image comparison logic 108 may determine a match between the image selection data and the data representing at least a portion the media object stored in media object database 110 by finding that the image selection data and data representing at least a portion of the media object have the same or similar hash value. In one example, if the hash comparison results in multiple entries having the same or nearly the same hash value, a more detailed comparison may be performed by image comparison logic 108, such as the fast Fourier Transform as applied to solving a degenerate sub-image problem.

In another example, client 102 may send an image or video to media server 100 as image selection data. Image comparison logic 108 may then create a hash of the image selection data as well as the media objects stored in media objects database 110. Image comparison logic 108 may determine a match between the image selection data and the data representing at least a portion the media object stored in media object database 110 by finding that the image selection data and data representing at least a portion of the media object have the same or similar hash value. In one example, if the hash comparison results in multiple entries having the same hash or nearly the same value, a more detailed comparison may be performed by image comparison logic 108, such as the fast Fourier Transform as applied to solving a degenerate sub-image problem.

In another example, where the image selection data includes an encoded broadcast packet, a binary match algorithm provides a quick and efficient method to find a match between the image selection data and the data representing at least a portion of the stored media objects. In another example, a comparison algorithm comparing a hash or fingerprint of the broadcast packet may be used instead of a binary match. In one example, the encoded broadcast packet may include a compressed video. For example, the encoded broadcast packet may be stored in MPEG or MPEG2 data formats.

Image comparison logic 108 may use an algorithm to compare the image selection data to data representing at least a portion of the media objects stored in media object database 110. However, a problem with this approach is that large media object databases and large image selection data can lead to long and computationally expensive searches. Thus, in one example, metadata associated with the first media object is obtained from the broadcast generated by provider 118 and is sent along with the image selection data in order to reduce the set of media objects compared using image comparison logic 108. Examples of the types of metadata that may be sent with the image selection data include the program name, program description, channel the program appeared on, television service provider, geographical location of the user, time the selection was made, and the amount of time into the program when the selection was made, information about the first user, information about the second user, and information associated with an advertisement. The examples are provided to illustrate the types of metadata that may be included and are not intended to be limiting.

In one example, media object database 110 may contain metadata associated with the media objects stored therein. This allows image comparison logic 108 to reduce the searchable set of media objects based on the metadata values. For instance, image selection data may include metadata indicating the selected video was broadcast in San Francisco on channel 3. Image comparison logic 108 may filter the media objects contained in media object database 108 by searching only those media objects that were broadcast in San Francisco on channel 3. Such filtering may reduce the amount of time and resources required to find a matching image or segment contained in a particular media object.

At block 206, the method includes identifying a segment of the second media object. The goal is to select a segment of the media object that corresponds to the segment marked by the user of client 102. In one example, this is done based on the comparison at block 204. For example, image comparison logic 108 may find a match between the image selection data and an image frame from a media object stored in media object database 110. Image comparison logic 108 may then select a segment of predetermined length or a length selected by the user from the stored media object, the segment starting with the identified frame. It should be appreciated by one of ordinary skill in the art that the segment need not start with the identified frame, but may use the frame as a point of reference. For instance, a segment may be selected that starts 20 seconds before the identified frame and continues until 20 seconds after the identified frame.

In one example, image comparison logic 108 may determine a match between the image frame sent as image selection data and the image displayed at 1 minute, 30 seconds into the video of a media object stored in media object database 110. Image comparison logic 108 may then select a 30 second segment of the media object starting at 1 minute, 30 seconds and ending at the 2 minute mark. It should be appreciated that any duration may be used when selecting the segment. The duration may be selected by default or set by the user. For instance, the duration may be selected by the user of client 102 and sent along with the image selection data. Further, it should be appreciated by those of ordinary skill in the art that the segment selected need not follow the identified frame of the media object stored in media object database 110. For instance, the 30 second segment may be selected to start at 1 minute, 15 seconds and end at 1 minute, 45 seconds into the video.

At block 208, the segment identified at block 206 is sent to a second user. The second user may be an individual (e.g., web user client 114), a server (e.g., social networking web server 112), or even the first user who sent the image selection data. The destination of the segment may be selectable by the user. For instance, the user of client 102 may select the destination to be a social networking server which may store the segment with an associated user account.

In one example, a “save for later” option may be provided to the first user through a television remote control, set-top box remote control, or the set-top box itself. The option may be selected from a menu or using a dedicated button on the television remote control, set-top box remote control, or the set-top box itself. The “save for later” option allows the first user to select an interesting segment or image on the television and have the selection stored in a predetermined located for later access. For example, the first user may press a “save for later” button on his/her television remote control causing client 102 to send image selection data associated with the media object to media server 100. Media server 100 may identify a segment of a second media object using the methods described herein and send the segment or a reference to the segment to an online account associated with the first user. The first user may then access the online account to view and interact with the segment corresponding to their selection.

In one example, media server 100 may send the segment to a second user through network 104 using web server 106. In another example, media server 100 may send the entire media object and data indicating the start and end points of the segment determined at block 206. In yet another example, sending the segment to a second user may include sending a reference to a location that the segment is stored. For instance, a web-link to a website that may play back the segment of video may be sent to the second user. Additionally, media server 100 may also transmit or cause the transmission of advertising data to the second user.

In one example, the second user and segment length may be predetermined, allowing the first user to select a segment of video using a single press of a button. For example, the segment length may be set to a default length of 30 seconds and the second user may be set to an online account associated with the first user. In this example, the first user may press a button on a remote control or make a selection from a menu indicating an interesting segment or image displayed on the television. Since the segment length and second user are known, no further input is required from the first user. The image selection data may be sent by client 102 to media server 100 which may identify a 30 second segment and send the segment, or a reference to the segment, to the online account associated with the first user.

In another example, the method of FIG. 2 may be used to allow a user to interact with the programming on the television. For example, a television game show may use the method of FIG. 2 to allow viewers to vote for their favorite contestants while watching their television. More specifically, in one example, the user may be instructed (e.g., by the game show through the interface of television 101) to make a selection while the user's favorite contestant is displayed on the television screen. For example, a picture or video clip may be displayed on television 101 along with an audio or visual message instructing the user of television 101 to press a button on the user's remote to vote for the contestant being displayed. The user may make his/her selection using the interface of television 101 and client 102, and client 102 may perform a screen capture and send the image as image selection data to media server 100. Image comparison logic 108 of media server 100 may identify the particular contestant by comparing the image selection data with data representing at least a portion of the media objects contained in media object database 110. Image comparison logic 108 may find a match and send the identity of the contestant to the game show's server to be counted as a vote. Alternatively, in another example, media server 100 may act as the game show server.

In another example, image comparison logic 108 may identify the selected contestant from the image selection data by comparing the image selection data to data representing at least a portion of the media objects associated with each contestant. For instance, media objects database 110 may contain media objects such as an image or video clip containing the particular contestant. The media object may further be associated with metadata identifying the displayed contestant by an identifier, such as name, contestant number, and the like. Image selection logic 108 may identify a media object from media object database 110 that is associated with the image selection data. The selected contestant may then be identified using the metadata associated with the media object from media object database 110.

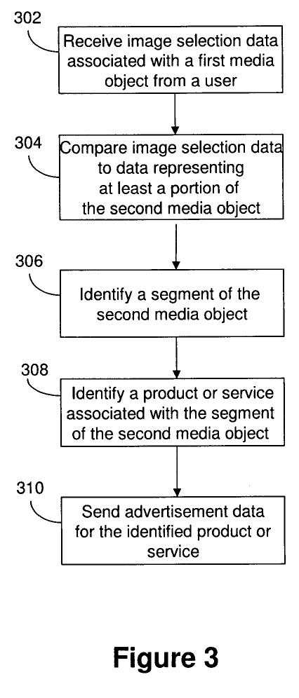

FIG. 3 illustrates an exemplary method for sending advertising data in response to receiving image selection data from a user of client 102. This allows a user to have information sent regarding a product or service seen on television. In one example, the user may select the destination of the advertising data. For example, the user may choose to have the information sent to himself/herself or to a friend.

At block 302, the method includes receiving image selection data associated with the first media object from a first user via client 102. The image selection data is similar to that of block 202 of FIG. 2. In one example, the user of television 101 may make a selection of the media object displayed on the user's television indicating that an interesting product or service is being advertised or displayed. The user may make this selection in order to obtain more information regarding the product or service seen on the television.

In one example, a user may make a selection while watching a television program indicating that he/she sees a product being shown that he/she would like to purchase in the future. For example, a user may see a skirt worn by an actress on a television show that she would like to purchase. The user may then press a button on the remote or set-top box to indicate that she would like more information regarding something being shown on the television. Client 102 may then send the image selection data to media server 100. Media server 100 may receive the image selection data and use it to identify the product the user selected in order to send the user more product information. The method of identifying the particular product or service will be discussed in greater detail below.

In another example, a separate button may be used on the remote control or set-top box to indicate that the user wishes to receive advertising data. If a user uses a separate button to request information, the image selection data may contain additional information indicating that the user is requesting information rather requesting that the segment of the media object be sent to a second user. In response to a selection, client 102 may send the image selection data, along with any metadata, to media server 100. Examples of metadata include program name, program description, channel the program appeared on, television service provider, geographical location of the user, time the selection was made, and the amount of time into the program when the selection was made, information about the first user, information about the second user, and information associated with an advertisement.

At block 304, media server 100 uses image comparison logic 108 to compare the received image selection data to data representing at least a portion of a second media object. The method of comparison is similar to that of block 204 of FIG. 2. Image comparison logic 108 may use one of the matching algorithms described above to identify a frame or segment from a media object stored in media object database 110 corresponding to the image selection data. It should be appreciated however, that image comparison logic 108 may receive the stored media objects from media object database 110 or an external media object source (e.g., advertisement server 116).

At block 306, the method includes identifying a segment of the second media object. The goal is to select a segment of the media object that corresponds to the segment marked by the user of client 102. In one example, this is done based on the comparison at block 304. For example, image comparison logic 108 may find a match between the image selection data and an image frame from a media object stored in media object database 110. Image comparison logic 108 may then select a segment of predetermined length from the stored media object, the segment starting with the identified frame. For example, image comparison logic 108 may determine a match between the image frame sent as image selection data and the image displayed at 1 minute, 30 seconds into the video of a media object stored in media object database 110. Image comparison logic 108 may then select a 30 second segment of the media object starting at 1 minute, 30 seconds and ending at the 2 minute mark. It should be appreciated that any duration may be used when selecting the segment. The duration may be selected by default or set by the user. For instance, the duration may be selected by the user of client 102 and sent along with the image selection data.

At block 308, media server 100 may use image comparison logic 108 or advertisement server 116 to identify a product or service associated with the segment of the second media object identified at block 306. This allows media server 100 to transmit or cause the transmission of relevant advertising data to the destination selected by the user.

In one example, the segment identified at block 306 may be associated with a commercial. Image comparison logic 108 may identify a particular product or service associated with the commercial. This may be accomplished in a variety of ways. For example, image comparison logic 108 may use metadata associated with the media object or a product lookup in an advertisement server or database. In one example, image comparison logic 108 may identify a product or service associated with a commercial based on the commercial's metadata identifying the product or service advertised. In another example, image comparison logic 108 may search an advertisement server or database to compare an image of the product with images of products stored in the server or database. In this example, the server or database may contain images of various products along with metadata identifying the product or service displayed by the image.

In another example, advertising data may be associated with a media object by advertisement server 116 without identifying a particular product or service associated with the media object. For example, advertising data may be associated with a media object based on the type of program selected. For instance, a user may send image selection data associated with a television cooking program. Image comparison logic 108 may determine a match between the image selection data and a second media object at block 304. Image comparison logic 108 may further determine that the program is a cooking program using associated metadata identifying the media object as such. In this example, media server 100 may request advertising data relating to cooking products and services from advertisement server 116.

At block 310, media server 100 may send advertising data associated with the product or service identified at block 306 to the user or the destination identified by the user. The advertising data may be stored in a server or database located within media server 100 or located remotely from the server. Advertising data may comprise additional information, such as coupons, samples, special offers, and the like. In one example, media server 100 may retrieve the advertising data from an advertisement database or server and send the information to the entity specified by the user.

In one example, media server 100 sends advertising data rather than the media object segment based on an indication by the user. For example, a user may press a button on a remote control or set-top box which indicates that he/she would like to receive advertising data related to the image displayed on television 101. In one example, the button on the remote control or set-top box may be separate from the button used to indicate an interesting segment or image displayed on the television. Data indicating that an advertising data request has been made may be sent from client 102 to media server 100. In one example, this data may be sent with image selection data.

In one example, advertisement server 116 may send advertising data in response to a request from media server 100. The advertising data may be sent directly to the requesting user, the media server, or to a third party, such as a social networking web server or a friend. Advertisement server 116 may send the advertising data through a communications network similar to network 104. Alternatively, if advertisement server 116 is directly connected to the destination, the use of network 104 may not be necessary.

In another example, advertisement server 116 may send the requested advertising data to media server 100. Media server 100 may then forward the advertising data to a user or social networking web server 112. In one example, media server 100 may send advertising data to a social networking web server 112 which may further display the advertisement to web user client 114. From a social networking user interface of social networking web server 112, a user of web user client 114 may view the advertising data. In one example, the advertising data may be a coupon which the user may print or use online. In other examples, advertisement server 116 may send the advertising data directly to a user or social networking web server 112 in response to a command from media server 100 to send the advertising data.

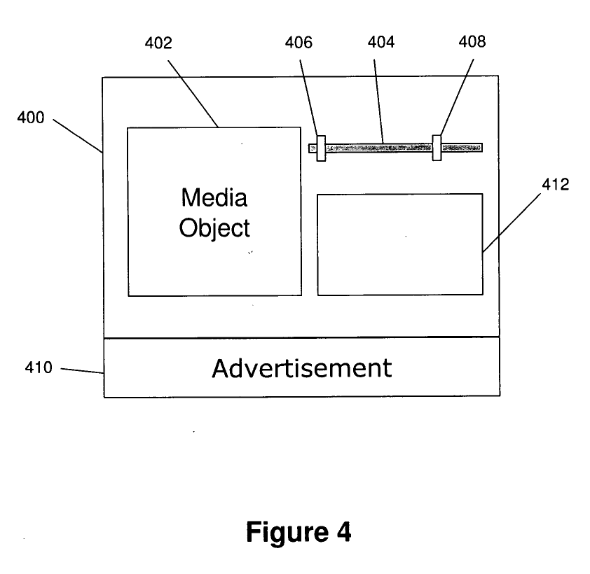

FIG. 4 illustrates an example of an interface for displaying the media object segments. For example, interface 400 may be used to display the segments sent by media server 100. Interface 400 may contain media object window 402 for displaying the selected segment of the second media object. Interface 400 may further include media object adjustment bar 404 for trimming the displayed media segment. Media object adjustment bar 404 may include trimming slide bars 406 and 408. Trimming slide bars 406 and 408 allow the user to edit the start and end time of the media object segment. For example, moving trimming slide bar 406 to the left selects an earlier segment start time, while moving it to the right selects a later start time. Similarly, moving trimming slide bar 408 to the left selects an earlier end time, while moving trimming slide bar 408 to the right selects a later select time.

In one example, interface 400 may include a tool for inputting data associated with a user. For example, a text entry field, pull down box, and the like may be provided to allow a first user to enter contact information for a second user (e.g., contact information for a friend or family member). The contact information may be entered in order to send advertising data or the selected segment to the second user.

In one example, interface 400 may further include advertisement portion 410. Advertisement portion 410 may be used to display an advertisement (e.g., an advertisement banner). In another example, the advertisement may be associated with the media object displayed in media object window 402. For example, an advertisement for a product may be displayed in advertisement portion 410 when an image of the product appears in media object window 402. Interface 400 may further include comment portion 412 for posting comments. Comment portion 412 allows web user client 114 to post comments about the media object that can be viewed by other web users.

In one example, interface 400 may further operate to allow a web user to request more information regarding the media object. For example, the web user may want to request price information about a product or service advertised in the media object. Interface 400 may allow the user to enter a mailing address or e-mail address to receive the pricing information.

In another example, interface 400 may be associated with an online account. The online account may be associated with a particular user of television 101 and client 102. Interface 400 may further allow users to enter information, such as user preferences, favorite media clips, comments, and the like.

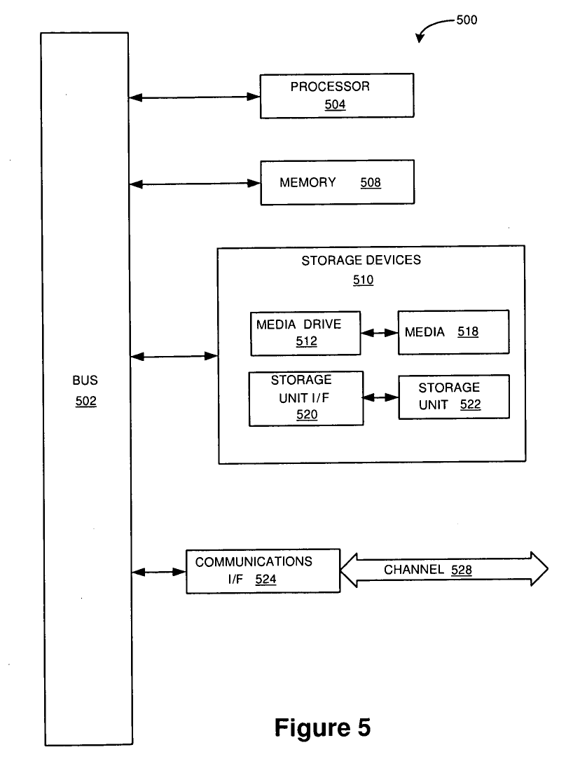

FIG. 5 illustrates an exemplary computing system 500 that may be employed to implement processing functionality for various aspects of the current technology (e.g., as a user/client device, media server, media capture server, media rules server, rules store, media asset library, activity data logic/database, combinations thereof, and the like.). Those skilled in the relevant art will also recognize how to implement the current technology using other computer systems or architectures. Computing system 500 may represent, for example, a user device such as a desktop, mobile phone, personal entertainment device, DVR, and so on, a mainframe, server, or any other type of special or general purpose computing device as may be desirable or appropriate for a given application or environment. Computing system 500 can include one or more processors, such as a processor 504. Processor 504 can be implemented using a general or special purpose processing engine such as, for example, a microprocessor, microcontroller or other control logic. In this example, processor 504 is connected to a bus 502 or other communication medium.

Computing system 500 can also include a main memory 508, such as random access memory (RAM) or other dynamic memory, for storing information and instructions to be executed by processor 504. Main memory 508 also may be used for storing temporary variables or other intermediate information during execution of instructions to be executed by processor 504. Computing system 500 may likewise include a read only memory (“ROM”) or other static storage device coupled to bus 502 for storing static information and instructions for processor 504.

The computing system 500 may also include information storage mechanism 510, which may include, for example, a media drive 512 and a removable storage interface 520. The media drive 512 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 518 may include, for example, a hard disk, floppy disk, magnetic tape, optical disk, CD or DVD, or other fixed or removable medium that is read by and written to by media drive 514. As these examples illustrate, the storage media 518 may include a computer-readable storage medium having stored therein particular computer software or data.

In alternative embodiments, information storage mechanism 510 may include other similar instrumentalities for allowing computer programs or other instructions or data to be loaded into computing system 500. Such instrumentalities may include, for example, a removable storage unit 522 and an interface 520, such as a program cartridge and cartridge interface, a removable memory (for example, a flash memory or other removable memory module) and memory slot, and other removable storage units 522 and interfaces 520 that allow software and data to be transferred from the removable storage unit 518 to computing system 500.

Computing system 500 can also include a communications interface 524. Communications interface 524 can be used to allow software and data to be transferred between computing system 500 and external devices. Examples of communications interface 524 can include a modem, a network interface (such as an Ethernet or other NIC card), a communications port (such as for example, a USB port), a PCMCIA slot and card, etc. Software and data transferred via communications interface 524 are in the form of signals which can be electronic, electromagnetic, optical, or other signals capable of being received by communications interface 524. These signals are provided to communications interface 524 via a channel 528. This channel 528 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product” and “computer-readable medium” may be used generally to refer to media such as, for example, memory 508, storage device 518, storage unit 522, or signal(s) on channel 528. These and other forms of computer-readable media may be involved in providing one or more sequences of one or more instructions to processor 504 for execution. Such instructions, generally referred to as “computer program code” (which may be grouped in the form of computer programs or other groupings), when executed, enable the computing system 500 to perform features or functions of embodiments of the current technology.

In an embodiment where the elements are implemented using software, the software may be stored in a computer-readable medium and loaded into computing system 500 using, for example, removable storage drive 514, drive 512 or communications interface 524. The control logic (in this example, software instructions or computer program code), when executed by the processor 504, causes the processor 504 to perform the functions of the technology as described herein.

It will be appreciated that, for clarity purposes, the above description has described embodiments of the technology with reference to different functional units and processors. However, it will be apparent that any suitable distribution of functionality between different functional units, processors or domains may be used without detracting from the technology. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the current technology has been described in connection with some embodiments, it is not intended to be limited to the specific form set forth herein. Rather, the scope of the current technology is limited only by the claims. Additionally, although a feature may appear to be described in connection with particular embodiments, one skilled in the art would recognize that various features of the described embodiments may be combined in accordance with the technology.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Although the current technology has been described in connection with some embodiments, it is not intended to be limited to the specific form set forth herein. Rather, the scope of the current technology is limited only by the claims. Additionally, although a feature may appear to be described in connection with a particular embodiment, one skilled in the art would recognize that various features of the described embodiments may be combined in accordance with the technology. Moreover, aspects of the technology described in connection with an embodiment may stand alone as a separate technology.

Moreover, it will be appreciated that various modifications and alterations may be made by those skilled in the art without departing from the spirit and scope of the technology. The current technology is not to be limited by the foregoing illustrative details, but is to be defined according to the claims.

What is claimed is:

1. A method for sharing media objects, the method comprising:
receiving image selection data associated with a first media object from a first user, wherein the first media object is a television broadcast video;
identifying a segment of a second media object by comparing the image selection data with data representing at least a portion of the second media object; and
sending the segment to a second user.

2. The method of claim 1, wherein the second media object is a copy of the first media object.

3. The method of claim 1, wherein the image selection data comprises at least one image from the first media object.

4. The method of claim 1, wherein the image selection data comprises a compressed video packet.

5. The method of claim 1, wherein the image selection data comprises a hash or fingerprint of at least one image from the first media object.

6. The method of claim 1, wherein identifying a segment of a second media object further comprises comparing metadata associated with the first media object with metadata associated with the second media object.

7. The method of claim 6, wherein the metadata associated with the first media object and the metadata associated with the second media object comprise at least one of program name, program description, current time, time into a program, channel, service provider, information about the first user, information about the second user, information associated with an advertisement, and viewing location.

8. The method of claim 1, wherein sending the segment to the second user comprises sending a web-link reference to the segment.

9. The method of claim 1, further comprising sending advertising data associated with the segment in response to receiving image selection data.

10. The method of claim 1, wherein the segment is sent over a communications network.

11. A method for counting votes, the method comprising:
receiving image selection data associated with a first media object from a user, wherein the first media object is a television broadcast video;
identifying a segment of a second media object by comparing the image selection data with data representing at least a portion of the second media object; and
counting a number of times image selection data associated the second media object is received.

12. A method for sending advertising data, the method comprising:
receiving image selection data associated with a first media object from a user, wherein the first media object is a television broadcast video;
identifying a segment of a second media object by comparing the image selection data with data representing at least a portion of the second media object; and
sending advertising data associated with the segment.

13. The method of claim 12, wherein the second media object is a copy of the first media object.

14. The method of claim 12, wherein the advertising data comprises at least one of product information or coupon.

15. The method of claim 12, wherein the advertising data is sent over a communications network.

16. The method of claim 1, wherein receiving comprises receiving image selection data from a client associated with the first user in response to a selection by the first user, wherein the second user and a length of the segment are predetermined, and wherein the selection by the first user is made by pressing a single button on a remote control or set-top box.

17. A system for sharing media objects, the system comprising:
memory for storing program code, the program code comprising instructions for:
receiving image selection data associated with a first media object from a first user, wherein the first media object is a television broadcast video;
identifying a segment of a second media object by comparing the image selection data with data representing at least a portion of the second media object; and
sending the segment to a second user; and
a processor for executing the instructions stored in the memory.

18. The system of claim 16, wherein the second media object is a copy of the first media object

19. The system of claim 16, wherein the image selection data comprises at least one image from the first media object.

20. The system of claim 16, wherein the image selection data comprises a compressed video packet.

21. The system of claim 16, wherein the image selection data comprises a hash or fingerprint of at least one image from the first media object.

22. The system of claim 16, wherein identifying a segment of a second media object further comprises comparing metadata associated with the first media object with metadata associated with the second media object.

23. The system of claim 21, wherein the metadata associated with the first media object and the metadata associated with the second media object comprise at least one of program name, program description, current time, time into a program, channel, service provider, information about the first user, information about the second user, information associated with an advertisement, and viewing location.

24. The system of claim 16, wherein sending the segment to the second user comprises sending a web-link reference to the segment.

25. The system of claim 16, wherein the program code further comprises instructions for sending advertising data associated with the segment in response to receiving image selection data.

26. The system of claim 16, wherein the segment is sent over a communications network.

27. The system of claim 16, wherein receiving comprises receiving image selection data from a client associated with the first user in response to a selection by the first user, wherein the second user and a length of the segment are predetermined, and wherein the selection by the first user is made by pressing a single button on a remote control or set-top box.

28. A computer readable storage medium comprising program code for sharing media objects, the program code for:
receiving image selection data associated with a first media object from a first user, wherein the first media object is a television broadcast video;
identifying a segment of a second media object by comparing the image selection data with data representing at least a portion of the second media object; and
sending the segment to a second user.

29. The computer readable storage medium of claim 28, wherein the second media object is a copy of the first media object

30. The computer readable storage medium of claim 28, wherein the image selection data comprises at least one image from the first media object.

31. The computer readable storage medium of claim 28, wherein the image selection data comprises a compressed video packet.

32. The computer readable storage medium of claim 28, wherein the image selection data comprises a hash or fingerprint of at least one image from the first media object.

33. The computer readable storage medium of claim 28, wherein identifying a segment of a second media object further comprises comparing metadata associated with the first media object with metadata associated with the second media object.

34. The computer readable storage medium of claim 33, wherein the metadata associated with the first media object and the metadata associated with the second media object comprise at least one of program name, program description, current time, time into a program, channel, service provider, information about the first user, information about the second user, information associated with an advertisement, and viewing location.

35. The computer readable storage medium of claim 28, wherein sending the segment to a second user comprises sending a web-link reference to the segment.

36. The computer readable storage medium of claim 28, further comprising program code for sending advertising data associated with the segment in response to receiving image selection data.

37. The computer readable storage medium of claim 28, wherein the segment is sent over a communications network.

38. The computer readable storage medium of claim 28, wherein receiving comprises receiving image selection data from a client associated with the first user in response to a selection by the first user, wherein the second user and a length of the segment are predetermined, and wherein the selection by the first user is made by pressing a single button on a remote control or set-top box.

39. An interface for displaying a media object, the interface comprising:
a display portion for displaying a segment of a first media object, the segment identified by comparing image selection data with data representing at least a portion of the first media object, the image selection data associated with the second media object; and
a graphical user element for adjusting a start point and an end point of the segment.

40. The interface of claim 39, wherein the graphical user element is a slidebar.

41. The interface of claim 39, further comprising an advertisement portion.

42. The interface of claim 39, further comprising a tool allowing a first user to input data associated with a second user, the segment to be sent to the second user.

43. The interface of claim 38, further comprising a tool allowing a first user to select a second user, the segment to be sent to the second user.
